(19) United States
(12) Patent Application Publication
(10) Pub. No.: US 2007/0180035 A1
(43) Pub. Date: Aug. 2, 2007

(54) E-mail attachment selectable download

(75) Inventors: Isaac Jian Liu, Qingdao (CN); May Ping Xu, Qingdao (CN)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/415,803

(22) Filed: May 1, 2006

(30) Foreign Application Priority Data
Jan. 28, 2006 (CN) 200610071113.6

(51) Int. Cl. G06F 15/16

(52) U.S. Cl. 709/206

(57) ABSTRACT

A method of transmitting e-mails with attachments over a communications network includes the steps of receiving an e-mail with an attachment file, causing the attachment file to be stored at a storage device, and transmitting a modified e-mail having an attachment indication with a pointer to a location of the attachment file at the storage device. The e-mail with an attachment file may be intended for a group of recipients. The e-mail with an attachment file may include text content. Further, the modified e-mail may include text content and the attachment indication. The attachment indication may include at least one of information on the size of the file, information as to the type of file, information as to the file creation date and information as to the last modification date.

### CROSS REFERENCE TO RELATED APPLICATIONS

This application is entitled to the benefit of and claims foreign priority under 35 U.S.C. § 119 from Chinese Patent Application No. 200610071113.6, filed Jan. 28, 2006, the disclosure of which is hereby incorporated by reference.

### FIELD OF THE INVENTION

The present invention relates to the field of electronic mail applications, and, more particularly, to managing electronic mail attachments.

### BACKGROUND OF THE INVENTION

Today, electronic mail, i.e. “e-mail,” is used all the time for exchanging or distributing information over computer communication networks. Examples of communications networks used for communicating e-mail messages include, but are not limited to, local area networks (LANs), wide area networks (WANs), the Internet, the World Wide Web, intranets, extranets, wireless networks and other networks over which electronic, digital, and/or analog data may be communicated. E-mail messages are created, sent, received, and read using a communications program, such as an “e-mail” application program. Most e-mail application programs allow one or more attachments, i.e. previously created files, to be transmitted with the e-mail message. Attachments may include, as non-limiting examples, text files, graphics files, video files, audio files, folders web pages and combinations thereof. To view the contents of an attachment, the recipient typically must select and open the attachment.

Attachments can be very large files. Moreover, one e-mail message may be sent with multiple attachments. Thus, any one e-mail message with attachments could take up a considerable amount of storage space on the recipient's computer. The concern with large attachments is compounded by the popularity of e-mail. As e-mail becomes ever more popular, even the memory storage devices of local nodes of the communication networks, which often store incoming e-mail messages and their attachments, may be overloaded. Therefore, it is desirable to reduce the number and volume of attachments that are stored either at the recipient's computer or at the memory storage devices of local nodes of the communication networks.

Not all recipients of e-mail messages want or need to receive the attachments. For example, managers, wanting to be kept informed that certain work is proceeding, may want to be included as recipients of e-mails, but do not necessarily need to read every attachment.

### SUMMARY OF THE INVENTION

According to an embodiment of the present invention, a method of transmitting e-mails with attachments over a communications network includes the steps of receiving an e-mail with an attachment file, causing the attachment file to be stored at a storage device, and transmitting a modified e-mail having an attachment indication with a pointer to a location of the attachment file at the storage device.

According to various aspects of the present invention, the step of causing the attachment file to be stored may include detaching the attachment file from the e-mail. Further, the step of causing the attachment file to be stored may include transmitting the attachment file to a storage device. The inventive method may further include the step of transmitting a copy of the stored attachment file to at least one recipient upon receiving a download command from the at least one recipient. The method may further include creating a counter equal to the number of recipients in the group.

According to another embodiment of the present invention, an apparatus for transmitting e-mail attachment files over a communications network, includes a network node configured to receive an e-mail with an attachment file, to cause the attachment file to be stored, and to transmit a modified e-mail having an attachment indication with a pointer to a stored location of the attachment file.

According to other various aspects of the present invention, the e-mail with an attachment file may be intended for a group of recipients and the modified e-mail may be transmitted to the intended group of recipients. The e-mail with an attachment file may include text content. Further, the modified e-mail may include text content and the attachment indication. The attachment indication may include at least one of information on the size of the file, information as to the type of file, information as to the file creation date and information as to the last modification date.

### BRIEF DESCRIPTION OF THE DRAWINGS

The present invention will be better understood from reading the following description of non-limiting embodiments, with reference to the attached drawings, wherein below:

FIG. 1 is a schematic of a communications network according to an embodiment of the present invention;

FIG. 2 is a flowchart illustrating another embodiment of the present invention; and

FIG. 3 is a flowchart illustrating another embodiment of the present invention.

### DETAILED DESCRIPTION

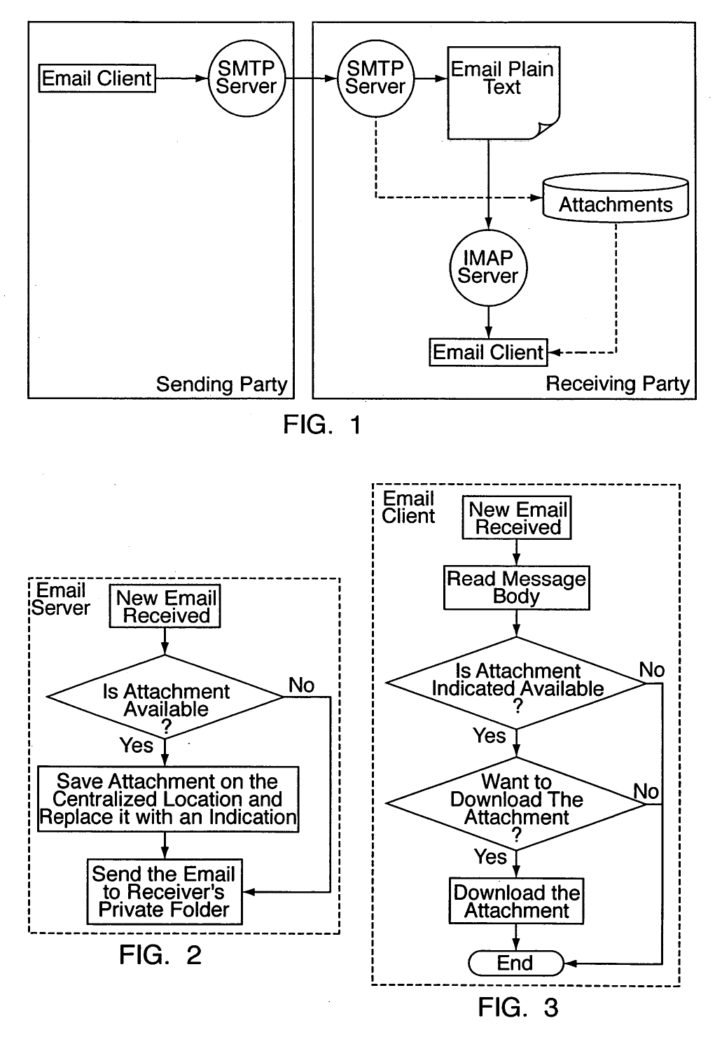

The present invention may be implemented on any networked node of a communication system. In a first embodiment, and referring to FIG. 1, there is shown a communications network involving at least one sending party and at least one receiving party. The sending and receiving parties may be interconnected via any of various communication channels and communication media that allow the transmission of e-mail messages from one client to another. E-mail messages may be sent or received, as non-limiting examples, on personal computers, personalized digital assistants (PDAs), and networked computers or other devices serving as servers, routers, post offices and/or storage devices.

Any of various communication software and protocol systems may be used with the networked systems. For example, FIG. 1 discloses the use of Simple Mail Transfer Protocol (SMTP) as a communication protocol for sending e-mail messages between servers and over the Internet and from mail clients to mail servers. Messages sent using SMTP can be retrieved by an e-mail client using communication protocols for retrieving e-mail messages, such as Internet Message Access Protocol (IMAP) or Post Office Protocol (POP).

With reference to FIG. 1, a first e-mail client representing a sending party generates an e-mail message with one or more attachment files. The e-mail message, itself, may include text content. The e-mail message with attachment files is transmitted via an SMTP server local to the sending party over the networked communication system.

On the receiving party side of the networked communication system, an SMTP server local to the receiving party receives the transmitted e-mail message with the attachment files. As best shown in FIG. 2, when a new e-mail message arrives at the receiving party's SMTP server, the receiving process invokes a content checking function. This content checking function determines if an attachment file has been transmitted with the e-mail message. If so, the processing software of the SMTP server removes the attachment file from the original e-mail message and saves it to a local storage device, such as a localized centralized post office.

An attachment indication is then created by the processing software of the SMTP server and attached to the original e-mail message. The attachment indication includes a location identifier indicating where the detached attachment file has been stored. In addition, in another aspect of the present invention, the attachment indication may also include information about certain selected attributes of the stored attachment file. For example, information identifying the size of the stored attachment file, the type of file, the date of creation, the author, the last modification date, etc. may all be included in attachment indication in addition to the address of the stored attachment file.

The e-mail message with attachment indication is then forwarded to the receiving party's e-mail boxes or private folder via, for example, an IMAP server, in the normal fashion.

In many instances, an e-mail message is distributed to a group of recipients, such as, by way of non-limiting example, multiple users that all share the same SMTP server. Therefore, in another aspect of the present invention, when the e-mail message with the attachment indication is distributed to each individual receiving parties' e-mail boxes, the SMTP server may generate a global reference counter indicating how may individual receiving parties' e-mail boxes the e-mail message with attachment indication is distributed to. This global reference counter is linked to the detached attachment file stored on local storage device. The global reference counter indicates how many locally distributed e-mail messages have attachment indications referring to the stored attachment file.

The receiving party's e-mail application needs to recognize the attachment indication. Thus, as best shown in FIG. 3, the receiving party's e-mail client application software checks to see if the incoming e-mail includes an attachment indication. If so, in one aspect of the present invention, the processing software of the e-mail application informs the receiving individual that an attachment file is available for downloading. For example, the receiving party may be queried, “Want to download the attachment?” The e-mail client processing software may then prompt the receiving individual to either select the stored attachment file, for example, for immediate downloading or saving to the receiving party's personal computer, or to delete the stored attachment file. In other words, the command for DOWNLOAD ATTACHMENT or DELETE ATTACHMENT may be generated by the receiving party's e-mail application software.

In another aspect of the present invention, the e-mail application provides the receiving individual with information about the stored attachment file that may have been included in the attachment indication, as discussed above.

The receiving party's local IMAP server receives and recognizes these two new actions or commands. When the IMAP server receives the command DOWNLOAD ATTACHMENT, it causes the stored attachment file to be located, based on the location identifier included in the attachment indication, and downloaded to the e-mail message residing in the individual receiving party's e-mail box. At the same time, the attachment indication is removed from the receiving party's e-mail message. In addition, the global reference counter, which is associated with the stored attachment file, is decremented by one.

In a similar fashion, when the command DELETE ATTACHMENT is received by the local IMAP server, the global reference counter is decremented by one. The attachment indication is removed from the e-mail message. The stored attachment file is not downloaded to the receiving party's e-mail box.

If the global reference counter reaches zero, this indicates that all of the plurality of recipients have either downloaded the attachment file or sent a delete command to the IMAP server. The stored attachment file is then deleted from the localized storage device.

In another aspect of the present invention, the stored attachment may be deleted after a predetermined time period has elapsed. Thus, if any one the receiving parties fails to either download or delete the stored attachment file, the stored attachment file will still be deleted from the storage device after a reasonable time period. This feature keeps unused and unwanted files from clogging the storage device.

The present invention encompasses a method and system whereby, instead of a full-size attachment file being transmitted to each of the individual receiving parties' mailboxes, only a much smaller attachment indication is transmitted along with the e-mail message. The full-size attachment file is stored at a local storage device for easy retrieval. The transmitted attachment indication includes a pointer to the actual location of the stored attachment file.

Since certain changes may be made in the above-described power saving system, without departing from the spirit and scope of the invention herein disclosed. For example, the stored attachment files may be encrypted or compressed prior to transmittal and storage. Further, multiple attachment files may be attached to any one e-mail message. In such a situation, multiple attachment indications may then be attached to the original e-mail message and transmitted to the receiving parties' e-mail boxes. It is intended that all of the subject matter of the above description or shown in the accompanying drawings shall be interpreted merely as examples illustrating the inventive concept herein and shall not be construed as limiting the invention.

We claim:

1. A method of transmitting e-mails with attachments over a communications network comprising the steps of:
receiving an e-mail with an attachment file;
causing the attachment file to be stored at a storage device; and
transmitting a modified e-mail having an attachment indication with a pointer to a location of the attachment file at the storage device.

2. The method of claim 1 wherein:
the e-mail with an attachment file is intended for a group of recipients and the modified e-mail is transmitted to the intended group of recipients.

3. The method of claim 1 wherein:
the e-mail with an attachment file includes text content.

4. The method of claim 1 wherein:
the modified e-mail includes text content and the attachment indication.

5. The method of claim 1 wherein:
the step of causing the attachment file to be stored includes detaching the attachment file from the e-mail.

6. The method of claim 1 wherein:
the step of causing the attachment file to be stored includes transmitting the attachment file to a storage device

7. The method of claim 1 further comprising the step of:
transmitting a copy of the stored attachment file to at least one recipient upon receiving a download command from the at least one recipient.

8. The method of claim 1 wherein:
the attachment indication further includes at least one of information on the size of the file, information as to the type of file, information as to the file creation date and information as to the last modification date.

9. The method of claim 2 further comprising the step of:
creating a counter equal to the number of recipients in the group.

10. The method of claim 10 further comprising the step of:
decrementing the counter by one when a command is received from a receiving party to download the stored attachment file or when a command is received from the receiving party to delete the stored attachment file.

11. The method of claim 10 further comprising the step of:
deleting the stored attachment file from the storage device when the counter equals zero.

12. The method of claim 1 further comprising the step of:
deleting the stored attachment file from the storage device after a certain predetermined time period has elapsed.

13. An apparatus for transmitting e-mail attachment files over a communications network, the apparatus comprising:
a network node configured to receive an e-mail with an attachment file, to cause the attachment file to be stored, and to transmit a modified e-mail having an attachment indication with a pointer to a stored location of the attachment file.

14. The apparatus of claim 13 wherein:
the e-mail with an attachment file is intended for a group of recipients and the modified e-mail is transmitted to the intended group of recipients.

15. The apparatus of claim 13 wherein:
the e-mail with an attachment file includes text content.

16. The apparatus of claim 13 wherein:
the modified e-mail includes text content and the attachment indication.

17. The apparatus of claim 13 wherein:
the attachment indication further includes at least one of information on the size of the file, information as to the type of file, information as to the file creation date and information as to the last modification date.

18. The apparatus of claim 13 wherein:
the network node is configured to create a counter equal to the number of recipients in the group.

19. The apparatus of claim 13 wherein:
the network node is configured to decrement the counter by one when a command is received from a receiving party to download the stored attachment file or when a command is received from the receiving party to delete the stored attachment file.

20. The apparatus of claim 13 wherein:
the communication network includes at least one of the internet, a LAN, a WAN and a wireless network.
